(19) United States
(12) Patent Application Publication
(10) Pub. No.: US 2016/0359908 A1
(43) Pub. Date: Dec. 8, 2016

(54) AUTOMATIC REAL-TIME ALERTING OF SECURITY HARDENING NON-COMPLIANCE

(71) Applicant: VMware, Inc., Palo Alto, CA (US)

(72) Inventor: William LAM, Sunnyvale, CA (US)

(21) Appl. No.: 14/728,659

(22) Filed: Jun. 2, 2015

(51) Int. Cl. H04L 29/06; G06F 9/455

(52) U.S. Cl. CPC H04L 63/20; H04L 63/1408; H04L 63/1433; G06F 9/45558; G06F 2009/45587

(57) ABSTRACT

In a computer-implemented method for automatic real-time alerting of security hardening non-compliance security policies of virtual machines in a virtualization infrastructure are accessed. Impending non-compliance of at least one of said security policies is determined. In response to the impending non-compliance of at least one of said security policies, a real-time alert of the impending non-compliance of at least one of the security policies is automatically generated.

### CROSS-REFERENCE TO RELATED APPLICATIONS

This application is related to co-pending U.S. patent application Ser. No. ______, filed on ______, entitled “AUTOMATIC SECURITY HARDENING OF AN ENTITY,” by William Lam having Attorney Docket No. C606.01, and assigned to the assignee of the present application.

This application is related to co-pending U.S. patent application Ser. No. ______, filed on ______, entitled “AUTOMATICALLY AUDITING VIRTUAL MACHINES FOR SECURITY HARDENING COMPLIANCE,” by William Lam having Attorney Docket No. C606.02, and assigned to the assignee of the present application.

This application is related to co-pending U.S. patent application Ser. No. ______, filed on ______, entitled “SECURITY HARDENING OF VIRTUAL MACHINES AT TIME OF CREATION,” by William Lam having Attorney Docket No. C606.04, and assigned to the assignee of the present application.

### BACKGROUND

Typically, security hardening of a virtual machine is performed either by manually entering security parameter settings or by an automated script written by the user. It is up to the user to fully understand the security parameters and properly configure the virtual machine such that the virtual machine has the appropriate and desired security hardening.

Moreover, when a virtual machine is security hardened by user intervention, the virtual machine is required to be taken offline. As a result, the virtual machine is unavailable for use while offline.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 depicts a block diagram of a virtualization infrastructure, according to various embodiments.

FIG. 2 depicts a block diagram of a virtualization infrastructure, according to various embodiments.

FIG. 3 depicts various parameters of various security policies, according to various embodiments.

FIG. 4 depicts a block diagram of an appliance, according to various embodiments.

FIG. 5 depicts a block diagram of a host computer system, according to various embodiments.

FIG. 6 depicts a flow diagram for a method for automatic security hardening of an entity, according to various embodiments.

FIG. 7 depicts a flow diagram for a method for automatic security hardening of a virtual machine, according to various embodiments.

FIG. 8 depicts a flow diagram for a method for automatic security hardening of a virtual machine, according to various embodiments.

FIG. 9 depicts a flow diagram for a method for automatically auditing virtual machines for security hardening compliance, according to various embodiments.

FIG. 10 depicts a flow diagram for a method for automatically auditing security hardening compliance of virtual machines, according to various embodiments.

FIG. 11 depicts a flow diagram for a method for remediating failed compliance of security hardening of virtual machines, according to various embodiments.

FIG. 12 depicts a flow diagram for a method for automatic real-time alerting of security hardening non-compliance, according to various embodiments.

FIG. 13 depicts a flow diagram for a method for automatic real-time alerting of security hardening non-compliance, according to various embodiments.

FIG. 14 depicts a flow diagram for a method for security hardening of virtual machines, according to various embodiments.

FIG. 15 depicts a flow diagram for a method for security hardening of virtual machines, according to various embodiments.

### DETAILED DESCRIPTION OF CERTAIN EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### I. Automatic Security Hardening of an Entity

### A. Embodiments of a Virtualization Infrastructure

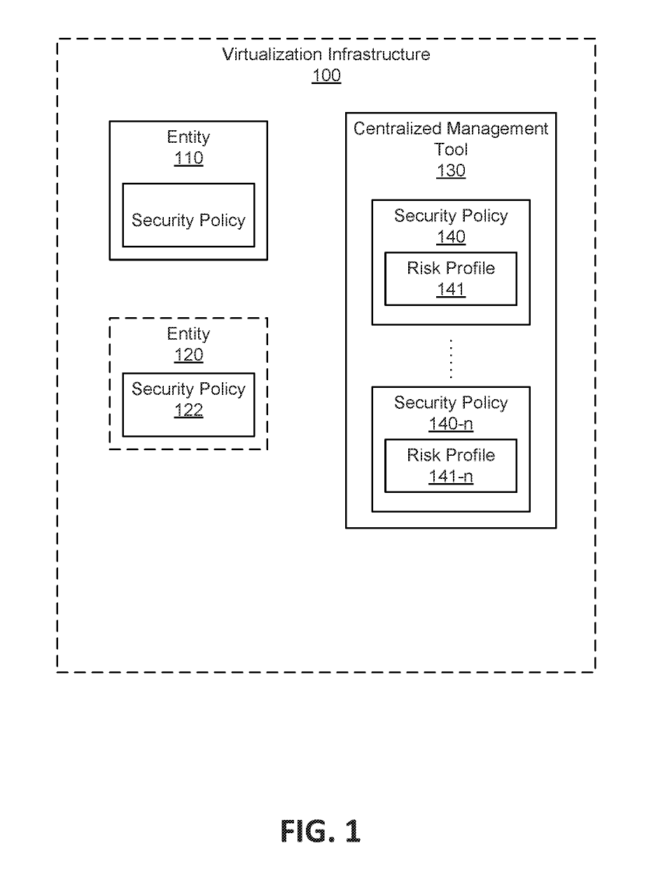

FIG. 1 depicts an embodiment of a block diagram of virtualization infrastructure 100. Virtualization infrastructure 100 can be any computing environment or network that supports virtualization (e.g., virtual machines, etc.) Virtualization infrastructure 100 includes, among other things, a plurality of entities (e.g., entity 110 and entity 120) for supporting the virtualization infrastructure, and centralized management tool 130.

In various embodiments, virtualization infrastructure 100 includes any number of physical and/or virtual machines. For example, in one embodiment, virtualization infrastructure 100 is a corporate computing environment that includes tens of thousands of physical and/or virtual machines. It is understood that a virtual machine is implemented in virtualization infrastructure 100 that includes one or some combination of physical computing machines. Virtualization infrastructure 100 provides resources, such as storage, memory, servers, CPUs, network switches, etc., that are the underlying hardware infrastructure.

The physical and/or virtual machines may include a variety of operating systems and applications (e.g., operating system, word processing, etc.). The physical and/or virtual machines may have the same installed applications or may have different installed applications or software. The installed software may be one or more software applications from one or more vendors.

Each virtual machine may include a guest operating system and a guest file system.

Moreover, the virtual machines may be logically grouped. That is, a subset of virtual machines may be grouped together in a container (e.g., VMware vApp™). For example, three different virtual machines may be implemented for a particular workload. As such, the three different virtual machines are logically grouped together to facilitate in supporting the workload. The virtual machines in the logical group may execute instructions alone and/or in combination (e.g., distributed) with one another. Also, the container of virtual machines and/or individual virtual machines may be controlled by a virtual management system. The virtualization infrastructure may also include a plurality of virtual datacenters. In general, a virtual datacenter is an abstract pool of resources (e.g., memory, CPU, storage). It is understood that a virtual data center is implemented on one or some combination of physical machines.

In various embodiments, virtualization infrastructure 100 may be a cloud computing environment. Virtualization infrastructure 100 may be located in an Internet connected datacenter or a private cloud computing center coupled with one or more public and/or private networks. Various computing systems, in one embodiment, may be coupled with a virtual or physical entity in virtualization infrastructure 100 through a network connection which may be a public network connection, private network connection, or some combination thereof. For example, a user may couple via an

Internet connection by accessing a web page or application presented by a computing system at a virtual or physical entity.

As will be described in further detail herein, the virtual machines are hosted by a host computing system. A host includes virtualization software that is installed on top of the hardware platform and supports a virtual machine execution space within which one or more virtual machines may be concurrently instantiated and executed.

In some embodiments, the virtualization software may be a hypervisor (e.g., a VMware ESX™ hypervisor, a VMware ESXi™ hypervisor, etc.) For example, if hypervisor is a VMware ESX™ hypervisor, then virtual functionality of the host is considered a VMware ESX™ server.

Additionally, a hypervisor or virtual machine monitor (VMM) is a piece of computer software, firmware or hardware that creates and runs virtual machines. A computer on which a hypervisor is running one or more virtual machines is defined as a host machine. Each virtual machine is called a guest machine. The hypervisor presents the guest operating systems with a virtual operating platform and manages the execution of the guest operating systems. Additional details regarding embodiments of structure and functionality of a host computer system are provided below.

During use, the virtual machines perform various workloads. For example, the virtual machines perform the workloads based on executing various applications. The virtual machines can perform various workloads separately and/or in combination with one another.

### B. Embodiments of Automatic Security Hardening

The entities, with respect to FIG. 1, are any components and/or functionality that are able to be automatically security hardened. In particular, the entities are able to be security hardened at the time the entities are created for use in virtualization infrastructure 100. The entities can be, but are not limited to, a virtual machine, ESXi hosts, a virtual network, a vCenter Server, vCenter Web Client, vCenter SSO Server, vCenter Virtual Appliance, vCenter Update Manager, and the like.

Centralized management tool 130, in various embodiments, is a central management point for virtualization infrastructure 100. In general, centralized management tool 130 is a suite of virtualization tools (e.g., vSphere suite). For example, centralized management tool 130 allows for the management of multiple ESX servers and virtual machines from different ESX servers through a single console application. Centralized management tool 130 can be stored and executed on an computing device (e.g., ESXi host) or can be stored and executed on another physical device (e.g., client device) that is communicatively coupled with virtualization infrastructure 100.

Centralized management tool 130 enables a user (e.g., IT administrator) to virtualization infrastructure 100 from a single or centralized tool, via a user interface. For example, resource utilization and/or health of nodes may be controlled via centralized management tool 130.

Additionally, centralized management tool 130 enables for centralized management and automated security hardening of entities in virtualization infrastructure 100. For example, centralized management tool 130 automates the association of security policies with an entity (e.g., virtual machine) at the time of creation of the entity.

For example, entity 120 may be a virtual machine that is created for use in virtualization infrastructure 100. In one embodiment, entity 120 is created via centralized management tool 130.

As entity 120 is created, it is associated with security policy 122 such that it is automatically security hardened. That is, the entity automatically inherits the parameters of the security policy, when the entity is created.

It should be appreciated that the term “created,” used herein, may describe the process of creation of an entity. For example, an IT administrator provides instructions, via centralized management tool 130, to create an entity to be deployed in virtualization infrastructure 100.

Additionally, the term “created” may refer to the time at which an entity (which may already be created) is deployed or provisioned within virtualization infrastructure. For example, entity 120 is removed from a first virtualization infrastructure and deployed in a second virtualization infrastructure (e.g., virtualization infrastructure 100). Accordingly, as entity 120 is re-deployed in the second virtualization infrastructure, the entity is automatically security hardened based on the association with security policy 122.

Entity 120 is then automatically security hardened as it is created and subsequently utilized in the virtualization infrastructure.

In general, security hardening is a process that facilitates in the reduction or elimination of attacks by patching vulnerabilities and turning off inessential services. Security hardening involves various steps to form layers of protection. As such, entities that are security hardened, as described herein, are deployed and operated in a secure manner.

Centralized management tool 130 includes or has access to one or more security policies to be associated with entities such that the entities are security hardened. For example, centralized management tool 130 includes security policy 140 through security policy 140-n. It should be appreciated that an entity may be associated with one of any number of the security policies. In one embodiment, an entity may be associated with one of three different security policies.

Each of the separate security policies includes a different risk profile. For example, security policy 140 includes risk profile 141, security policy 140-n includes risk profile 141-n, while other security policies include a different risk profile.

Each risk profile describes the relative increase in risk security. For example, a first security policy includes a first risk profile with a low security risk threshold, while a second security policy includes a second risk profile with a medium security risk threshold (e.g., higher security than the low risk threshold). Likewise, a third security policy includes a third risk profile with a high security risk threshold (e.g., higher security than the medium risk threshold).

The security policy associated with an entity is typically selected based on its risk profile. For instance, an IT administrator may provide instructions that any new virtual machine includes a security policy that includes a low security risk profile because the intended workload on the new virtual machine is a low threat to any security issues.

In various embodiments, the security policies are pre-defined recommended security policies. That is, the security policies are created (prior to the creation of the entity) as recommended security policies having various risk thresholds.

The security policies, in one embodiment, are created/provided by the same party that created/provided centralized management tool 130. In another embodiment, the security policies are created/provided by a party that is different than the party that created/provided centralized management tool 130.

In one embodiment, the security policies are custom made. For example, a user (e.g., IT administrator) accesses a pre-defined security policy and modifies the security policy to suit the particular security needs for the entity. In another embodiment, a user creates an original security policy to suit the particular security needs for the entity.

It should be appreciated that user instructions may be provided such that centralized management tool 130 automatically associates a security policy with an entity, wherein the instructions are provided by a user interface of centralized management tool 130, an application program interface (API), or a command line interface (CLI).

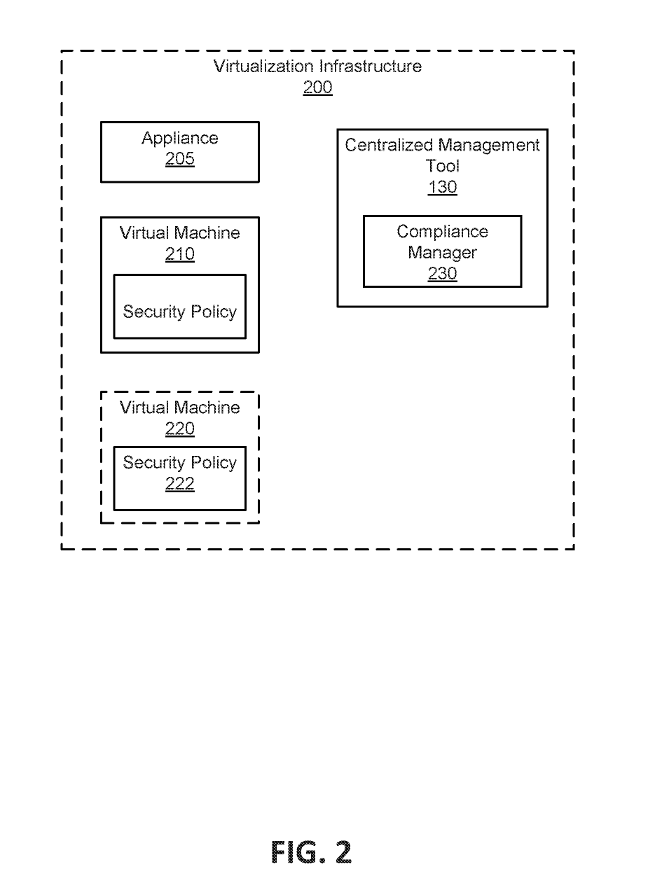

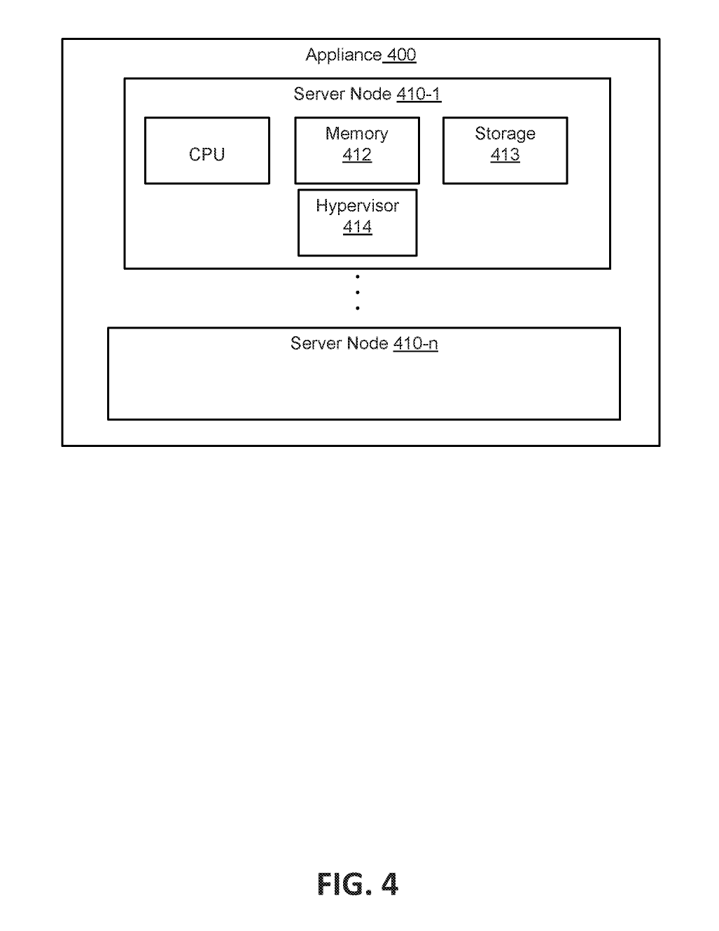

FIG. 2 depicts an embodiment of a block diagram of virtualization infrastructure 200. Virtualization infrastructure 200 is similar to virtualization infrastructure 100. However, virtualization infrastructure 200 is particular to automated security hardening of virtual machines (e.g., virtual machine 210 and virtual machine 220) at time of creation of the virtual machines, wherein the virtual machines are hosted by an appliance. It is noted that the virtual machines are hosted by one or more appliances (e.g., appliance 205). In one embodiment, the appliances are pre-configured hyper-converged computing devices, which will be described in further detail below, with respect to at least FIG. 4.

During the creation of virtual machine 220, centralized management tool 130 automatically associates security policy 222 with virtual machine 220. Virtual machine 220 is then automatically security hardened when it is first utilized in virtualization infrastructure.

In one embodiment, one or more virtual machines (e.g., virtual machine 220) are created immediately subsequent the first powering on of appliance 205. For example, appliance 205 is configured to immediately create virtual machines in virtualization infrastructure 200 upon its initial powering on. As such, virtual machine 220 is created immediately subsequent the first powering on of appliance 205.

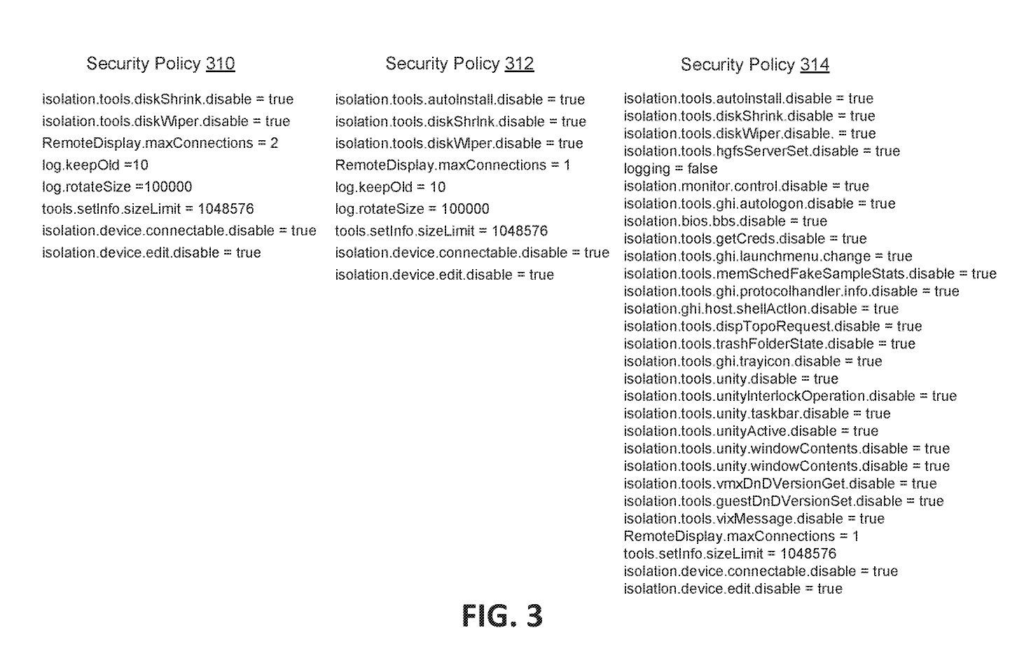

Security policy 222 may be any one of various security policies. For example, security policy 222 is any one of the security policies depicted in FIG. 3, which will be described in further detail below.

In one embodiment, during the creation of a virtual machine, the virtual machine is assigned various parameters. Such parameter may include name, resource provisioning (e.g., number of CPUs, amount of storage, amount of memory), etc.

It should be appreciated that a user may be prompted to determine if a security policy is to be associated with a virtual machine. For example, during the process of creating a virtual machine, a user is prompted to decide whether or not a virtual machine is to be associated with a security policy. If the user selects no, then the virtual machine is created without a security policy. If the user selects yes, then the virtual machine is associated with a security policy.

Moreover, the user may be prompted to select which security policy is to be associated with a virtual machine. For example, the user may be prompted to select between various security policies, each having a different risk profile.

In one embodiment, one of the security policies is a recommended security policy (or default security policy). If such recommended or default security policy is selected by the user, then the recommended or default security policy is associated with the virtual machine. Moreover, a default security policy may be selected at various levels of the inventory tree for the centralized management tool. Accordingly, any virtual machine created by centralized management tool will automatically inherit the default security policy.

In various embodiments, the security policy may be locally stored in the virtual machine. For example, during creation of a virtual machine, the various parameters (e.g., key value pairs) of a security policy are pulled into an “extraconfig” field of the virtual machine. As such, the security policy is associated with the virtual machine regardless of where the virtual machine is deployed. For example, if a virtual machine is redeployed into another system/network, then the security policy automatically moves with the virtual machine.

In another embodiment, the security policy may be located remotely from the virtual machine, such as in a database. For example, the security policy is located on a security policy engine integrated with centralized management tool 130. A mapping indicates which virtual machines (or other entities) are associated with which security policies.

In another example, an API may provide for an automatic redirect that jumps to the security policy engine. Via the API, the security policy engine indicates that that various virtual machines are associated with particular security policies, such as virtual machine 210 is associated with security policy 212 and virtual machine 220 is associated with security policy 222. In one embodiment, each of the security policies are given a unique identification (e.g., a universal unique identification (UUID)). In such an embodiment, the API may reference a UUID of a security to determine which virtual machines are associated with security policy having the referenced UUID.

As described herein, in various embodiments, a security policy may be customized by a user. The customization may be implemented by a wizard. For example, the wizard helps the user walk through the various parameters (e.g., key/value pairs).

It should be appreciated that the available security parameters are based on the release of the particular software release of centralized management tool 130. For instance, a first set of security parameters are available for selection with respect to a first release of the centralized management tool 130. The first set of security parameters may not be available for selection with respect to a subsequent release of the centralized management tool 130. However, a second set of security parameters may be available for selection with respect to the subsequent release of the centralized management tool.

In various embodiments, the security policy that a virtual machine is associated with may change. That is, a virtual machine may be initially associated with a first security policy (e.g., security policy 140) and the virtual machine may subsequently associated with a second security policy (e.g., security policy 140-n). During the transition to an association with another security profile, the virtual machine remains online. In other words, it is not necessary for the virtual machine to go off line while transitioning from a first security profile to a second security profile.

### C. Embodiments of Security Policies

FIG. 3 depicts embodiments of various security policies. The security policies (i.e., security policy 310, security policy 312, and security policy 314) each have different risk profiles. For example, security policy 310 includes a first risk profile with a low security risk threshold. Security policy 312 includes a second risk profile with a medium security risk threshold (e.g., higher security than the low risk threshold). Security policy 314 includes a third risk profile with a high security risk threshold (e.g., higher security than the medium risk threshold).

Each of the security policies includes various security parameters. The parameters, in one embodiment, are key/value pairs. For example, each of the security policies include the key “RemoteDisplay.maxConnections.” However, the value for each of the keys may be different based on the risk profile of the security policy. For instance, in regards to security policy 310 and security policy 312, the value for above mentioned key is 2. In regards to security policy 314, the value for the above mentioned key is 1.

It is noted that security policies 310, 312, and 314, in one embodiment, are security policies 130 through 130-n, as depicted in FIG. 1. It should be appreciated security policies 310, 312, and 314 may include additional parameters (e.g., key/value pairs).

### D. Embodiments of an Appliance

FIG. 4 depicts an embodiment of appliance 400. Appliance 400 is a computing device that includes the requisite physical hardware and software to create and manage a virtualization infrastructure. Appliance 400 is also referred to herein as a pre-configured hyper-converged computing device. In general, a hyper-converged computing device includes pretested, pre-configured and pre-integrated storage, server and network components, including software, that are located in an enclosure. Moreover, the hyper-converged computing device includes a hypervisor that supports a virtualization infrastructure.

Based on the pre-configured hardware and software disposed within appliance 400, appliance 400 enables a user to simply and quickly create a virtualization infrastructure and deploy virtual machines shortly after the appliance is powered on for the first time.

Appliance 300 includes, among other things, at least one server node. For example, server nodes 410-1 through server node 410-n. Server node 410-1 includes a central processing unit (CPU) 411, memory 412, and storage 413. It should be appreciated that other server nodes (i.e., server node 410-n) each include a CPU, memory, and storage similar to server node 410-n.

Additionally, each server node includes a hypervisor. For example, server node 410-1 includes hypervisor 414 and server node 410-n also includes a hypervisor. A hypervisor is installed on top of hardware platform (e.g., CPU, memory and storage) and supports a virtual machine execution space within which one or more virtual machines (VMs) may be concurrently instantiated and executed.

In various embodiments, a hypervisor is VMware ESX™ hypervisor or a VMware ESXi™ hypervisor. It is noted that “ESX” is derived from the term “Elastic Sky X” coined by VMware™. Additionally, as stated above, if hypervisor is a VMware ESX™ hypervisor, then virtual functionality of the host is considered a VMware ESX™ server. Moreover, although the node is physical hardware it includes hypervisor functionality based on the hypervisor implemented on the server node.

Appliance 400 is scalable. That is appliance can be scaled to include more than one server node. For example, appliance 400 can initially have a single server node. However, additional server nodes may be included in appliance 400.

In one embodiment, appliance 400 is able to deploy a plurality of virtual machines in the virtualization infrastructure. For example, based on the hardware and software incorporated in appliance 400, appliance 400 is able to deploy pre-set number of virtual machines (e.g., 75 virtual machines, 150 virtual machines, etc.).

Moreover, each server node may be considered a server or host computing system. That is, each server node is able to independently host a number of virtual machines. For example, server node 410-1 is able to host a first set of virtual machines, while other server nodes are each able to independently host other sets of virtual machines, respectively.

The server nodes are independent of one another, and are not required to share any functionality with one another. Appliance 400 does not include a backplane. As such, the server nodes are isolated from one another and therefore independent of one another.

CPU 411 may be, but is not limited to, a dual socket CPU (e.g., Intel Xeon™ CPUs, 4-core to 6-core).

Memory 412 may be, but is not limited to, 128 gigabytes (GB).

Storage may be, but is not limited to, three drive slots per node. Such as a solid state drive (SSD) (e.g., an SSD up to 800 GB), and two hard disk drives (HDD) (e.g., HDDs up to 8 terabytes (TB)).

Additionally, the appliance may include various external interfaces, such as but not limited to, serial, network RJ-45 (10000 NIC), graphics, management RJ-45 (100/10000 NIC), power (in front and in rear), UID (in front and in rear) and a USB.

The appliance may also include Component Interconnect Express (PCIe) expansion slots, and a disk controller with pass through capabilities. It should be appreciated that the appliance may include other hardware attributes that are compatible with supporting a virtualization infrastructure.

In one embodiment, appliance 400 is a rackable 2 U/4 Node appliance. That is, appliance 400 is two rack units in height and includes four server nodes (e.g., server nodes 410-1 through 410-n).

The size of a piece of rack-mounted equipment is described as a number in “U” or “RU” (rack unit). One rack unit is often referred to as “1 U”, 2 rack units as “2U” and so on. “U” is a unit of measure that describes the height of equipment designed to mount in a rack (e.g., 19-inch rack or a 23-inch rack). The 19-inch (482.6 mm) or 23-inch (584.2 mm) dimension refers to the width of the equipment mounting frame in the rack including the frame. In some instances, one rack unit is 1.75 inches (4.445 cm) high.

In another embodiment, appliance 400 is a 4 U/4 Node appliance. That is, appliance 400 is four rack units in height and includes 4 server nodes (e.g., server nodes 410-1 through 410-n).

Appliance 400 includes software to support a virtualization infrastructure. That is, appliance 400 includes code or instructions stored on physical hardware in appliance 400, that when executed by a processor, supports a virtualization infrastructure. For instance, appliance 400 includes pre-configured software module.

It should be appreciated that the software installed on appliance 400 is stored in a storage device. In various embodiments, the software may be installed in a single server node or may be distributed in various server nodes. In another embodiment, the software may be stored in a storage device within appliance 400 but is outside of the server nodes.

During operation of the appliance, the software may be executed by one or more CPUs in a single server node or the execution may be distributed amongst various CPUs in various server nodes.

It should be appreciated that the software module, in one embodiment, includes a suite of software tools for cloud computing (e.g., VMware vSphere™

VCenter^{TM}) that utilizes various components such as a VMware ESX/ESXi hypervisor. Accordingly, the software module may be a controlling module for at least appliance 400 based on the controlling software tools (e.g., VMware vSphere™, VCenter™)

The software module, in one embodiment, includes a centralized management tool for an appliance or a cluster of appliances. The centralized management tool, in one embodiment, is for the management of multiple ESX hosts and virtual machines (VMs) from different ESX hosts through a single console application. It should be appreciated that the virtualization infrastructure, or portions of the virtualization infrastructure may be managed by the centralized management tool via a user interface. Additionally, the centralized management tool manages or controls the hypervisors in appliance 400. For example, the centralized management tool controls the hypervisor it runs in and controls the other hypervisors in the other nodes.

### E. Embodiments of a Host Computer System

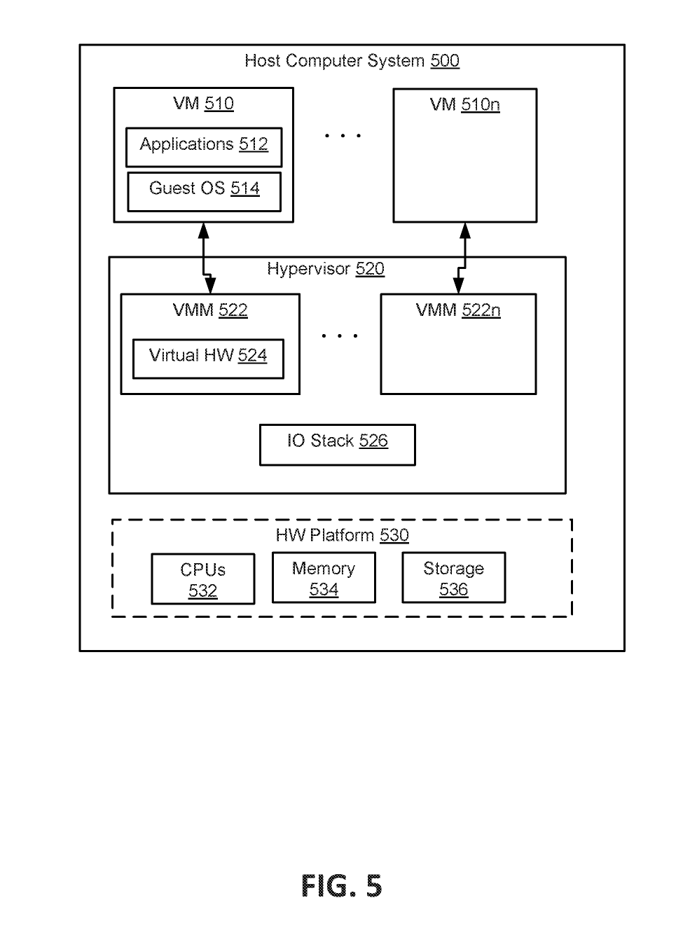

FIG. 5 is a schematic diagram that illustrates a host computer system that is configured to carry out one or more embodiments of the present invention. Host computer system 500 in one embodiment is appliance 400. Host computer system 500 includes, among other things, virtual machines 510 through 510n, hypervisor 520, and hardware platform 530.

Hardware platform 530 includes one or more central processing units (CPUs) 532, system memory 534, and storage 536. Hardware platform 530 may also include one or more network interface controllers (NICs) that connect host computer system 500 to a network, and one or more host bus adapters (HBAs) that connect host computer system 500 to a persistent storage unit.

Hypervisor 520 is installed on top of hardware platform 530 and supports a virtual machine execution space within which one or more virtual machines (VMs) may be concurrently instantiated and executed. Each virtual machine implements a virtual hardware platform that supports the installation of a guest operating system (OS) which is capable of executing applications. For example, virtual hardware 524 for virtual machine 510 supports the installation of guest OS 514 which is capable of executing applications 512 within virtual machine 510.

Guest OS 514 may be any of the well-known commodity operating systems, and includes a native file system layer, for example, either an NTFS or an ext3FS type file system layer. IOs issued by guest OS 514 through the native file system layer appear to guest OS 514 as being routed to one or more virtual disks provisioned for virtual machine 510 for final execution, but such IOs are, in reality, reprocessed by IO stack 526 of hypervisor 520 and the reprocessed lOs are issued, for example, through an HBA to a storage system.

Virtual machine monitor (VMM) 522 and 522n may be considered separate virtualization components between the virtual machines and hypervisor 520 (which, in such a conception, may itself be considered a virtualization “kernel” component) since there exists a separate VMM for each instantiated VM. Alternatively, each VMM may be considered to be a component of its corresponding virtual machine since such VMM includes the hardware emulation components for the virtual machine. It should also be recognized that the techniques described herein are also applicable to hosted virtualized computer systems. Furthermore, although benefits that are achieved may be different, the techniques described herein may be applied to certain non-virtualized computer systems.

### F. Example Methods of Operation

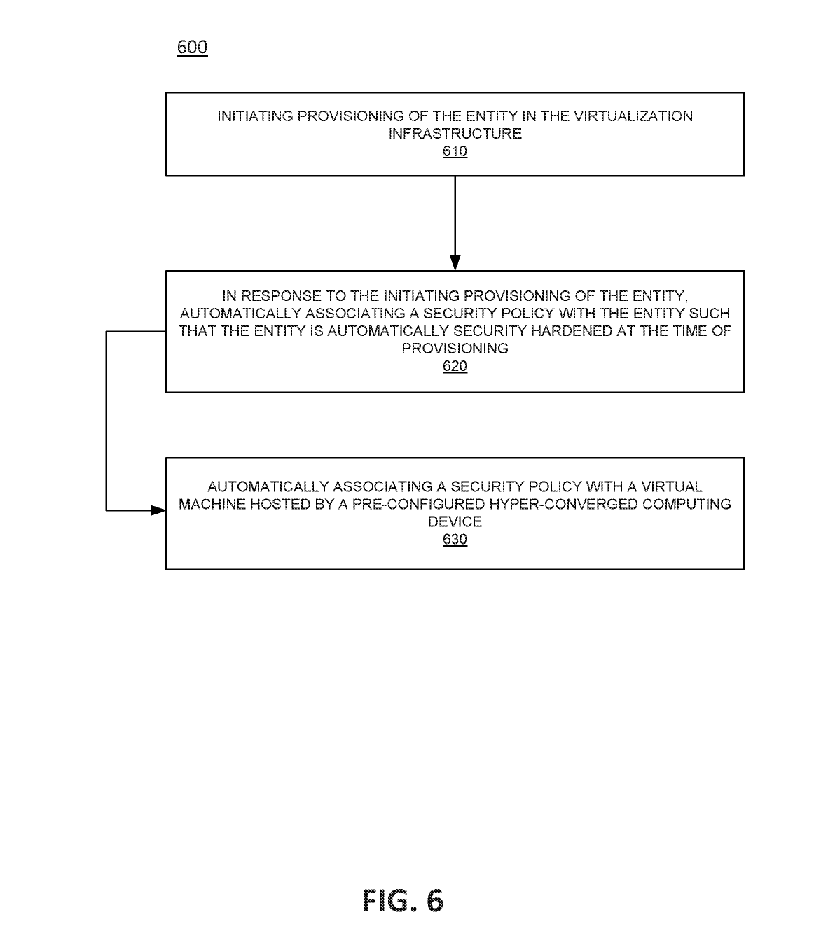

The following discussion sets forth in detail the operation of some example methods of operation of embodiments. With reference to FIGS. 6, 7 and 8, flow diagrams 600, 700 and 800 illustrate example procedures used by various embodiments. Flow diagrams 600, 700 and 800 include some procedures that, in various embodiments, may include some steps that are carried out by a processor under the control of computer-readable and computer-executable instructions. In this fashion, procedures described herein and in conjunction with flow diagrams 600, 700 and 800 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in flow diagrams 600, 700 and 800 such procedures are examples. That is, embodiments are well suited to performing various other procedures or variations of the procedures recited in flow diagrams 600, 700 and 800. Likewise, in some embodiments, the procedures in flow diagrams 600, 700 and 800 may be performed in an order different than presented and/or not all of the procedures described in one or more of these flow diagrams may be performed.

FIG. 6 depicts a process flow diagram 600 of a method for automatic security hardening of an entity at time of creation, according to various embodiments.

At 610, initiating provisioning of the entity in the virtualization infrastructure. For example, instructions are provided by a user (e.g., IT administrator) to create or provision an entity 120 (e.g., a virtual machine) in virtualization infrastructure 100.

At 620, in response to the initiating provisioning of the entity, automatically associating a security policy to the entity such that the entity is automatically security hardened at the time of provisioning. For example, centralized management tool 130 receives the instructions to create/provision the entity. In response, during the creation/provisioning of the entity, centralized management tool 130 automatically associates security policy 122 with entity 120. As a result, entity 120 is automatically security hardened at the time of creation/provisioning.

At 630, automatically associating a security policy to a virtual machine hosted by a pre-configured hyper-converged computing device. For example, centralized management tool 130 associates security policy 122 with entity 120 (e.g., a virtual machine), wherein the virtual machine is hosted by a pre-configured hyper-converged computing device.

It is noted that any of the procedures, stated above, regarding flow diagram 600 may be implemented in hardware, or a combination of hardware with firmware and/or software. For example, any of the procedures are implemented by a processor(s) of a cloud environment and/or a computing environment.

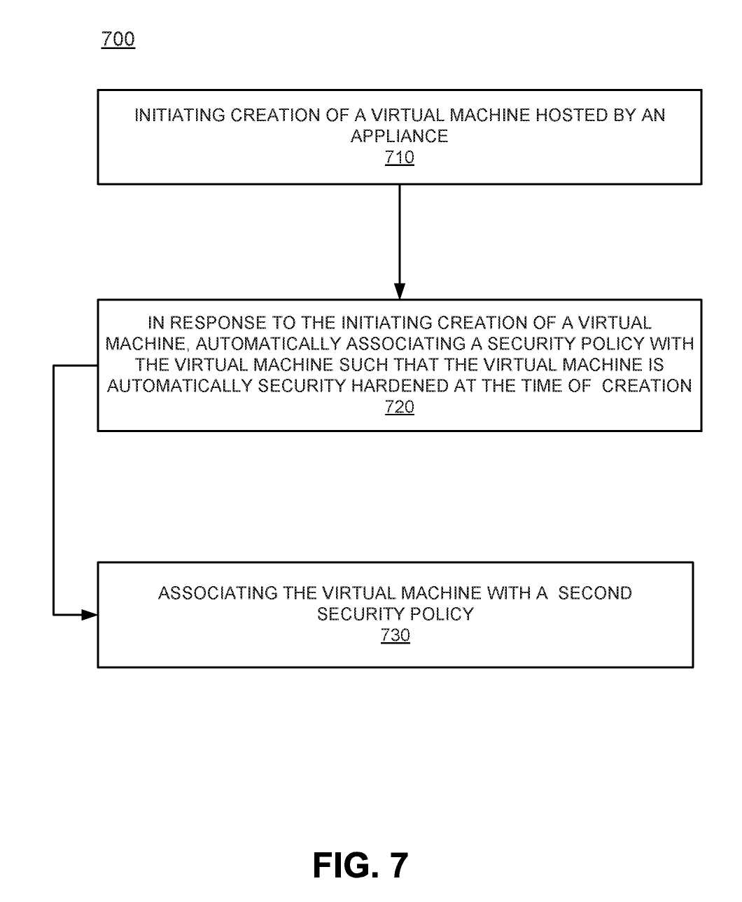

FIG. 7 depicts a process flow diagram 700 of a method for automatic security hardening of a virtual machine, according to various embodiments.

At 710, initiating creation of a virtual machine hosted by an appliance. For example, instructions are provided by a user (e.g., IT administrator) to create virtual machine 220 for use in virtualization infrastructure 200.

At 720, in response to the initiating creation of a virtual machine, automatically associating a security policy to the virtual machine such that the virtual machine is automatically security hardened at the time of creation. For example, centralized management tool 130 receives the instructions to create the virtual machine. In response, during the creation of virtual machine 220, centralized management tool 130 automatically associates security policy 222 with virtual machine 220. As a result, virtual machine 220 is automatically security hardened at the time of creation.

At 730, associating the virtual machine from a first security policy to a second security policy. For example, virtual machine 220 is initially associated with security policy 222. Centralized management tool 130 may associate virtual machine 220 with another security policy (e.g., one having a higher risk profile) to replace security policy 222. It is noted that during the transitioning between security policies, the virtual machine remains on line and is not required to be taken off line.

It is noted that any of the procedures, stated above, regarding flow diagram 700 may be implemented in hardware, or a combination of hardware with firmware and/or software. For example, any of the procedures are implemented by a processor(s) of a cloud environment and/or a computing environment.

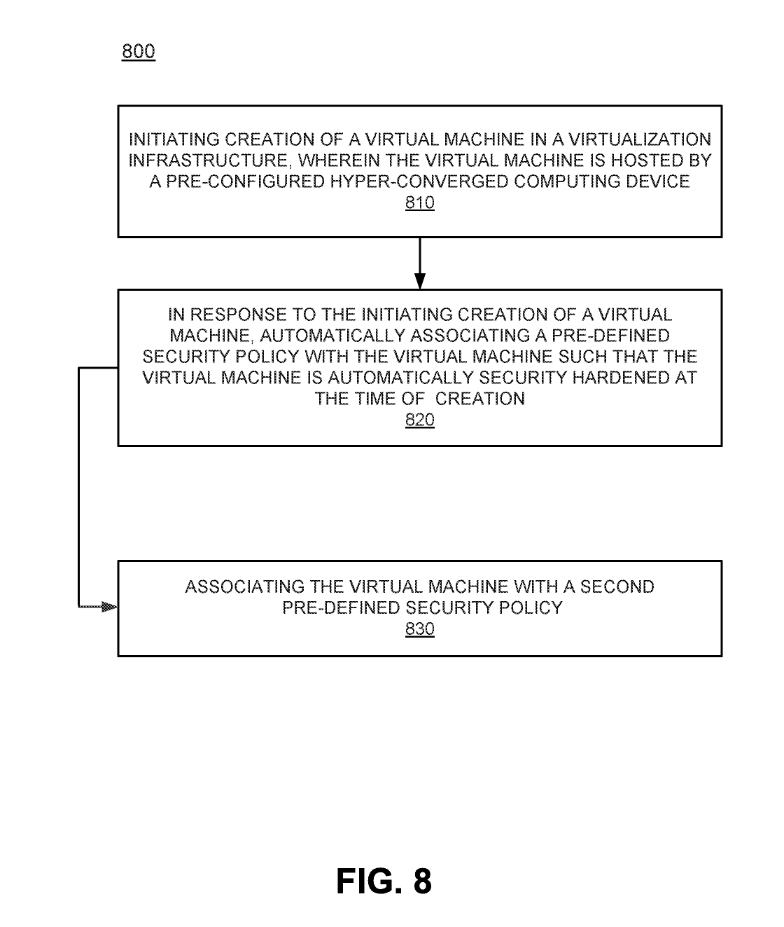

FIG. 8 depicts a process flow diagram 800 of a method for automatic security hardening of a virtual machine, according to various embodiments.

At 810, initiating creation of a virtual machine in a virtualization infrastructure, wherein the virtual machine is hosted by a pre-configured hyper-converged computing device. For example, instructions are provided by a user (e.g., IT administrator) to create virtual machine 220 for use in virtualization infrastructure 200. The virtual machine is hosted by appliance 205 which is a pre-configured hyper-converged computing device.

At 820, in response to the initiating creation of a virtual machine, automatically associating a pre-defined security policy to the virtual machine such that the virtual machine is automatically security hardened at the time of creation. For example, centralized management tool 130 receives the instructions to create the virtual machine. In response, during the creation of virtual machine 220, centralized management tool 130 automatically associates security policy 222 with virtual machine 220. As a result, virtual machine 220 is automatically security hardened at the time of creation.

At 830, associating the virtual machine from a first pre-defined security policy to a second pre-defined security policy. For example, virtual machine 220 is initially associated with security policy 222. Centralized management tool 130 may associate virtual machine 220 with another security policy (e.g., one having a higher risk profile) to replace security policy 222. It is noted that during the transitioning between security policies, the virtual machine remains on line and is not required to be taken off line.

It is noted that any of the procedures, stated above, regarding flow diagram 800 may be implemented in hardware, or a combination of hardware with firmware and/or software. For example, any of the procedures are implemented by a processor(s) of a cloud environment and/or a computing environment.

Ii. Automatically Auditing Virtual Machines for Security Hardening Compliance

### A. Automated Auditing of Virtual Machines for Security Hardening Compliance

As will be described in further detail below, centralized management tool 130 provides for automated auditing of virtual machines for security hardening compliance.

Referring again to FIG. 2, centralized management tool 130, in various embodiments, includes centralized compliance manager 230 (e.g., vCloud Air) for automatically auditing virtual machines in virtualization infrastructure 200. In general, centralized compliance manager 230 checks the compliance of virtualization infrastructure 200 against specific standards and best practices that are applicable for the environment. The auditing facilitates in ensuring that virtualization infrastructure 200 remains secure and compliant. Specific standards may be governmental standards, Health Insurance Portability and Accountability Act (HIPPA) security standards, contractually based standards, etc.

More specifically, centralized compliance manager 230 accesses the virtual machines in virtualization infrastructure 200 to determine whether or not the security policies associated with the virtual machines are in compliance. Accessing of the security policies may be periodic. For example, centralized compliance manager 230 periodically accesses (e.g., daily, weekly, monthly, etc.) the security policies in virtualization infrastructure 200 to confirm whether or not the security policies are in compliance to an expected standard (e.g., HIPPA security standards). Alternatively, accessing of the security policies may be in response to user input. For example, a standards auditor requests an audit of virtualization infrastructure 200. In response, a user (e.g., IT administrator) provides user input to instruct centralized compliance manager 230 to access the security policies in virtualization infrastructure 200 for auditing.

In various embodiments, compliance auditing may be performed concurrently across multiple ESX and ESXi servers. As a result, an audit report may be generated that includes results across multiple ESX and ESXi servers.

Compliance monitoring and auditing, in various embodiments, are performed on the current state of virtualization infrastructure 200. For example, centralized compliance manager 230 accesses the security policies currently associated with the virtual machines to determine whether or not the current state of virtualization infrastructure 200 is in compliance.

In various embodiments, results of security hardening compliance are logged or archived such that may be accessed for subsequent use. In such an embodiment, the periodic results of security hardening compliance are stored such that previous states of virtualization infrastructure 200 may be audited. For example, an audit of a previous state of virtualization infrastructure 200 may be performed based the accessing of logged security hardening compliance results previously performed. In such an example, virtual machine 210 and virtual machine 220 each were associated with a previously security policy with a low risk threshold (e.g., security policy 311) at time T1. The results of which were stored for later use. At time T2 (e.g., 6 month later), virtual machines 210 and 220 are associated with a new security policy with a higher risk threshold (e.g., security policy 314). Additionally, at time T2, a security hardening audit was performed on virtualization infrastructure 200 to determine if any of the virtual machines were out of compliance within the past year. The audit determined that security policy 311 associated with virtual machines 210 and 220 at time T1 were not in compliance.

In another example, virtual machine 210 was provisioned in virtualization infrastructure 200 at time T1. However, at time T2 (e.g., 6 month later) virtual machine 210 is no longer provisioned in virtualization infrastructure 200. Additionally, at time T2, a security hardening audit was performed on virtualization infrastructure 200 to determine if any of the virtual machines were out of compliance within the past year. The audit determined that the security policy associated with virtual machine 210 which was in virtualization infrastructure 200 at time T1 was in compliance.

### B. Remediating Security Hardening Non-Compliance

As will be described in further detail below, centralized management tool 130 facilitates in the remediation of non-compliance of security hardening of virtual machines.

In one embodiment, if any of the virtual machines are not in compliance for the appropriate security hardening, then the audit report indicates the particular virtual machines that are not in compliance. A user (e.g., IT administrator) may view the report and manually replace the security profiles of the non-compliant virtual machines with compliant security profiles.

In another embodiment, compliance manager 230 may automatically remediate the security hardening non-compliance. For example, if it is determined that virtual machine 220 is non-compliant because security policy 222 is non-compliant, then compliance manager 230 automatically replaces security policy 222 with a compliant security policy. As a result, virtual machine 220 is associated with a new security policy such that virtual machine 220 is security hardening compliant.

### C. Example Methods of Operation

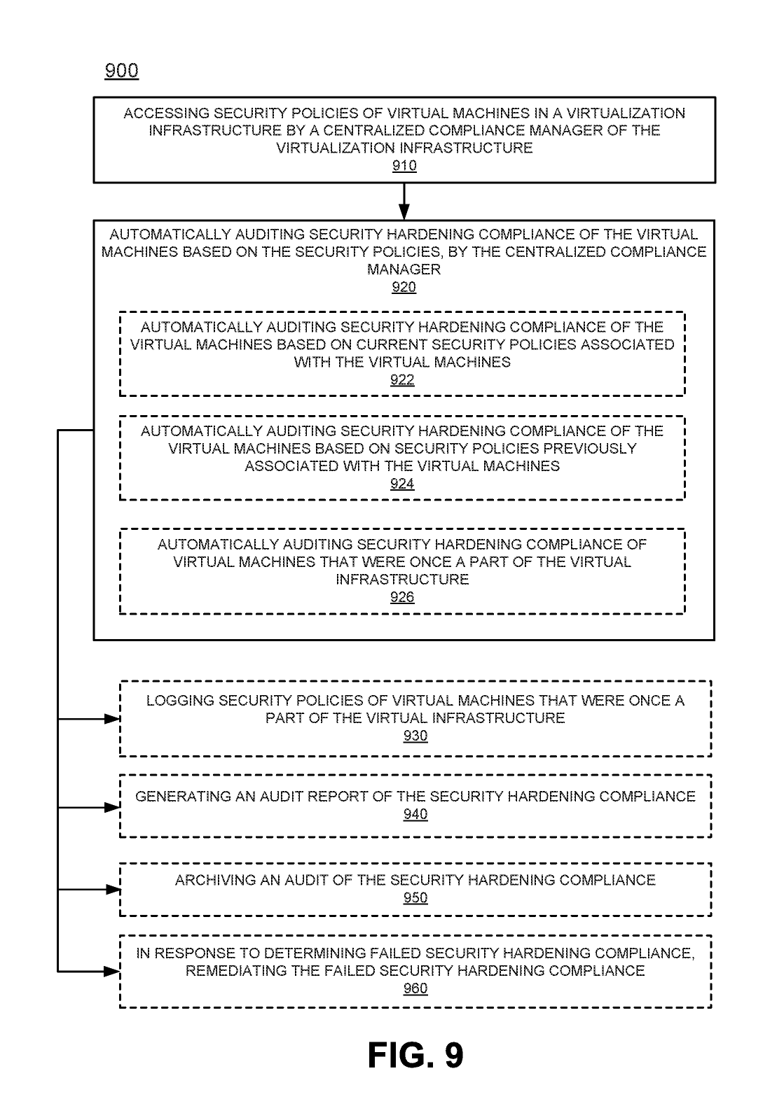

The following discussion sets forth in detail the operation of some example methods of operation of embodiments. With reference to FIGS. 9, 10 and 11, flow diagrams 900, 1000 and 1100 illustrate example procedures used by various embodiments. Flow diagrams 900, 1000 and 1100 include some procedures that, in various embodiments, may include some steps that are carried out by a processor under the control of computer-readable and computer-executable instructions. In this fashion, procedures described herein and in conjunction with flow diagrams 900, 1000 and 1100 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in flow diagrams 900, 1000 and 1100 such procedures are examples. That is, embodiments are well suited to performing various other procedures or variations of the procedures recited in flow diagrams 900, 1000 and 1100. Likewise, in some embodiments, the procedures in flow diagrams 900, 1000 and 1100 may be performed in an order different than presented and/or not all of the procedures described in one or more of these flow diagrams may be performed.

FIG. 9 depicts a process flow diagram 900 of a method for automatically auditing virtual machines for security hardening compliance, according to various embodiments.

At 910, accessing security policies of virtual machines in a virtualization infrastructure by a centralized compliance manager of the virtualization infrastructure. For example, centralized compliance manager 230 of centralized management tool 130 accesses security policies of every virtual machine (e.g., virtual machines 210 and 220) in a selected environment (e.g., virtualization infrastructure 200, cluster of appliances, database, etc.)

At 920, automatically auditing security hardening compliance of the virtual machines based on the security policies, by the centralized compliance manager. For example, centralized compliance manager 230 then audits security hardening compliance of the virtual machines by analyzing the security policies to determine if the security policies meet the compliance requirements (e.g., HIPPA security compliance).

At 922, in one embodiment, automatically auditing security hardening compliance of the virtual machines based on current security policies associated with the virtual machines. For example, auditing is performed on security hardening compliance with respect to the current security policies (e.g., security policies 212 and 222) for the virtual machines that are currently provisioned in virtualization infrastructure 200 (e.g., virtual machines 210 and 220).

At 924, in another embodiment, automatically auditing security hardening compliance of the virtual machines based on security policies previously associated with the virtual machines. For example, auditing is performed on security hardening compliance at a previous state of virtualization infrastructure 200. For instance, virtual machines 210 and 220 were initially associated with security policy 310. As such, the auditing was based on the virtual machines when they were previously associated with security policy 310.

At 926, automatically auditing security hardening compliance of virtual machines that were once a part of the virtual infrastructure. For example, virtual machines 210 and 220 were once a part of virtualization infrastructure but have since been removed. However, an audit may still be performed as to whether or not machines virtual machines 210 and 220 were in compliance during the time when they were provisioned in the virtualization infrastructure. This is done, based on the archiving of past compliance determinations.

At 930, logging security policies of virtual machines that were once a part of the virtual infrastructure. For example, a virtual machine may change security policies. The history of security policies for a virtual machine is logged. The stored history of security policies may be accessed for subsequent security hardening compliance auditing.

At 940, generating an audit report of the security hardening compliance. For example, an audit report is generated that indicates which virtual machines are in compliance and which virtual machines are not in compliance.

At 950, archiving an audit of the security hardening compliance. For example, centralized compliance manager 230 may periodically determine security hardening compliance. The stored periodic determinations may be accessed for subsequent security hardening compliance auditing.

At 960, in response to determining failed security hardening compliance, remediating the failed security hardening compliance. For example, if an audit determines that a virtual machine is not in compliance, then the virtual machine is associated with a different security policy that is in compliance.

It is noted that any of the procedures, stated above, regarding flow diagram 900 may be implemented in hardware, or a combination of hardware with firmware and/or software. For example, any of the procedures are implemented by a processor(s) of a cloud environment and/or a computing environment.

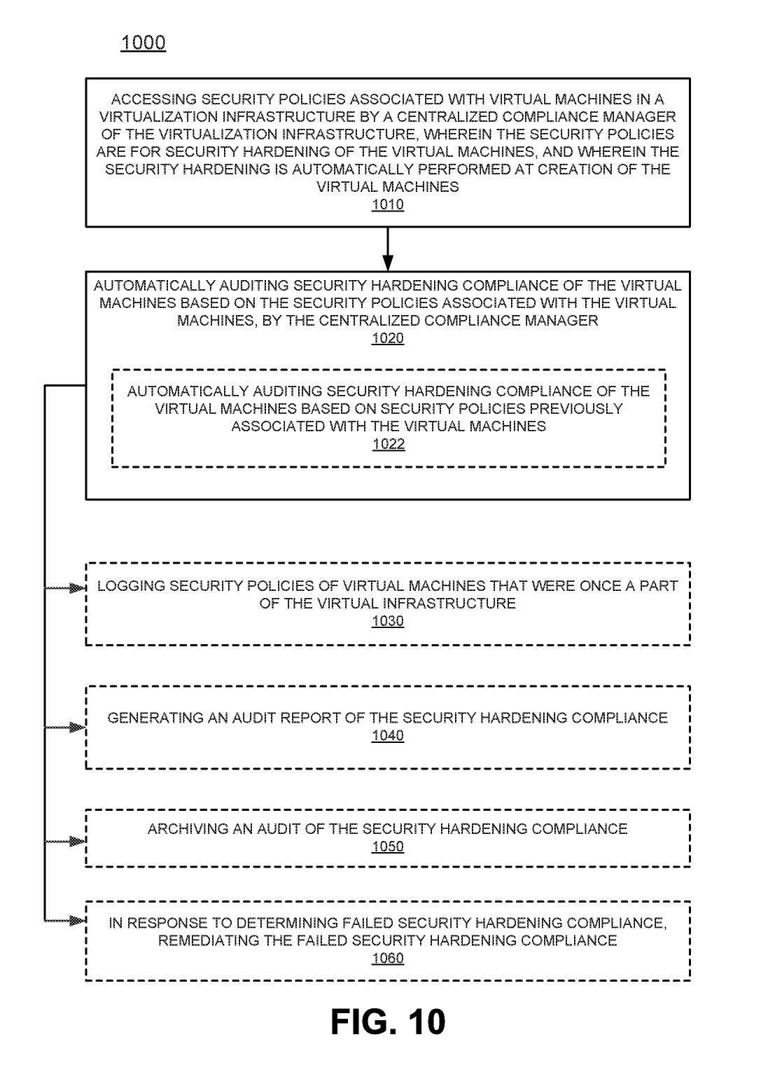

FIG. 10 depicts a process flow diagram 1000 of a method for automatically auditing security hardening compliance of virtual machines, according to various embodiments.

At 1010, accessing security policies associated with virtual machines in a virtualization infrastructure by a centralized compliance manager of the virtualization infrastructure, wherein the security policies are for security hardening of the virtual machines, and wherein the security hardening is automatically performed at creation of the virtual machines. For example, centralized compliance manager 230 accesses security policies of virtual machines in a selected environment (e.g., virtualization infrastructure 200). It is noted that the security policies are associated with the virtual machines at time of creation of the virtual machines such that the virtual machines are automatically security hardened at the time of creation.

At 1020, automatically auditing security hardening compliance of the virtual machines based on the security policies associated with the virtual machines, by the centralized compliance manager. For example, centralized compliance manager 230 then audits security hardening compliance of the virtual machines by analyzing the associated security policies to determine if the security policies meet the compliance requirements (e.g., HIPPA security compliance).

At 1022, automatically auditing security hardening compliance of the virtual machines based on security policies previously associated with the virtual machines. For example, auditing is performed on security hardening compliance at a previous state of virtualization infrastructure 200. For instance, virtual machines 210 and 220 were initially associated with security policy 310. As such, the auditing was based on the virtual machines when they were previously associated with security policy 310.

At 1030, logging security policies of virtual machines that were once a part of the virtual infrastructure. For example, a virtual machine may change security policies. The history of security policies for a virtual machine is logged. The stored history of security policies may be accessed for subsequent security hardening compliance auditing.

At 1040, generating an audit report of the security hardening compliance. For example, an audit report is generated that indicates which virtual machines are in compliance and which virtual machines are not in compliance.

At 1050, archiving an audit of the security hardening compliance. For example, centralized compliance manager 230 may periodically determine security hardening compliance. The stored periodic determinations may be accessed for subsequent security hardening compliance auditing.

At 1060, in response to determining failed security hardening compliance, remediating the failed security hardening compliance. For example, if an audit determines that a virtual machine is not in compliance, then the virtual machine is associated with a different security policy that is in compliance.

It is noted that any of the procedures, stated above, regarding flow diagram 1000 may be implemented in hardware, or a combination of hardware with firmware and/or software. For example, any of the procedures are implemented by a processor(s) of a cloud environment and/or a computing environment.

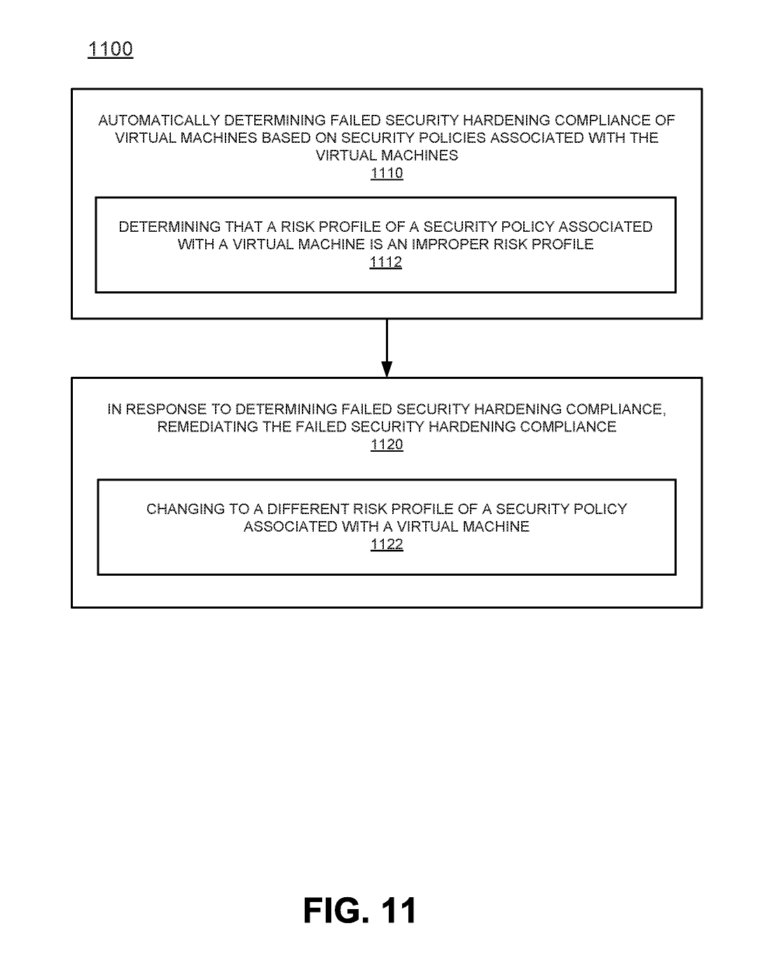

FIG. 11 depicts a process flow diagram 1100 of a method for remediating failed compliance of security hardening of virtual machines, according to various embodiments.

At 1110, automatically determining failed security hardening compliance of virtual machines based on security policies associated with said virtual machines. For example, centralized compliance manager 230 accesses security policies of virtual machines in a selected environment and automatically determines whether or not the virtual machines are in compliance of security hardening based on the security policies associated with the virtual machines.

At 1112, determining that a risk profile of a security policy associated with a virtual machine is an improper risk profile. For example, centralized compliance manager 230 accesses security policies having a particular risk profile of virtual machines in a selected environment and automatically determines whether or not the virtual machines are in compliance of security hardening based on the risk profiles of the security policies associated with the virtual machines.

At 1120, in response to determining failed security hardening compliance, remediating said failed security hardening compliance. For example, if an audit determines that a virtual machine is not in security hardening compliance, then the virtual machine is associated with a different security policy that is in security hardening compliance.

At 1122, changing to a different risk profile of a security policy associated with a virtual machine. For example, it is determined that virtual machine 210 is non-compliance because the virtual machine is associated with security policy 310 (having a low risk profile). Centralized compliance manager 230 then associates the virtual machine with security policy 314 which has a higher risk profile and is security hardening compliant.

It is noted that any of the procedures, stated above, regarding flow diagram 1100 may be implemented in hardware, or a combination of hardware with firmware and/or software. For example, any of the procedures are implemented by a processor(s) of a cloud environment and/or a computing environment.

### III. Automatic Real-Time Alerting of Security Hardening Non-Compliance

### A. Embodiments of Automatic Real-Time Alerting of Security Hardening Non-Compliance

As will be described in further detail below, centralized management tool 130 provides for automated real-time alerting of security hardening non-compliance.

Referring to FIG. 2, centralized management tool 130, in various embodiments, includes centralized compliance manager 230 (e.g., vRealize Operations Manager) for providing automated real-time alerts when there is non-compliance of security hardening. In general, centralized compliance manager 230 checks the compliance of virtualization infrastructure 200 against specific standards and best practices that are applicable for the environment. In response to determining non-compliance, centralized compliance manager 230 generates an alert to indicate non-compliance or impending non-compliance. Specific standards may be governmental standards, HIPPA security standards, contractually based standards, etc.

More specifically, centralized compliance manager 230 accesses the virtual machines in virtualization infrastructure 200 to determine whether the security policies associated with the virtual machines are in non-compliance or are impending non-compliance.

A virtual machine may be in non-compliance of security hardening if a security policy associated with the virtual machine has an improper risk threshold. For example, virtual machine 210 may be associated with security policy 310 when the security hardening requirements for virtual machine 210 require it to be associated with security policy 314. Also, virtual machine 210 may be associated with security policy 312, but the workload assigned to virtual machine 210 requires virtual machine to be associated with security policy 314. As such, virtual machine 210 is non-compliant to the security hardening requirements.

Moreover, in another example, virtual machine 210, associated with security policy 312, may have an impending non-compliance because a workload that is intending to be assigned to virtual machine 210 requires that the virtual machine be associated with security policy 314 having a different risk profile.

If it is determined that there is non-compliance or impending non-compliance of a virtual machine, then centralized compliance manager 230 generates an alert of the non-compliance or impending non-compliance.

The alert can be in many forms. For example, the alert may be a message displayed on a UI of centralized management tool 130 to be viewed by a user. The alert can also include a sound. Additionally, the alert can be in the form of an email, text message, etc.

In response to viewing the alert, a user may remediate the non-compliance or impending non-compliance, by various means. For example, a user may provide instructions to centralized management tool 130 to remove the virtual machine from the virtualization infrastructure, or to replace the existing non-compliant security policy with a compliant security policy.

### B. Example Methods of Operation

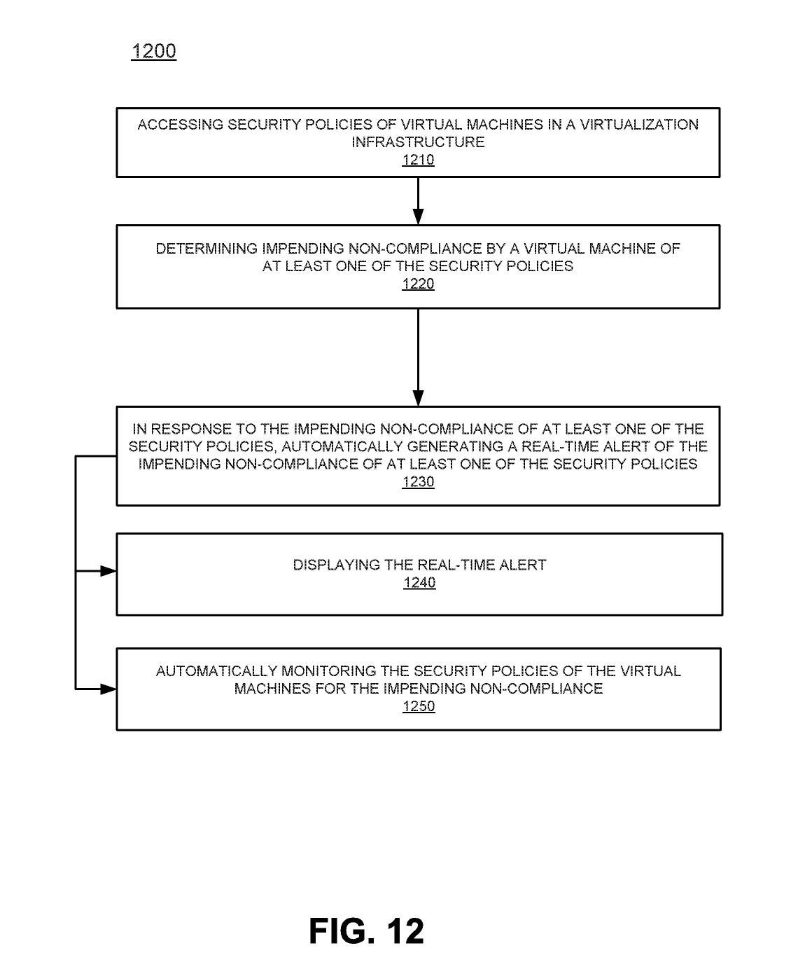

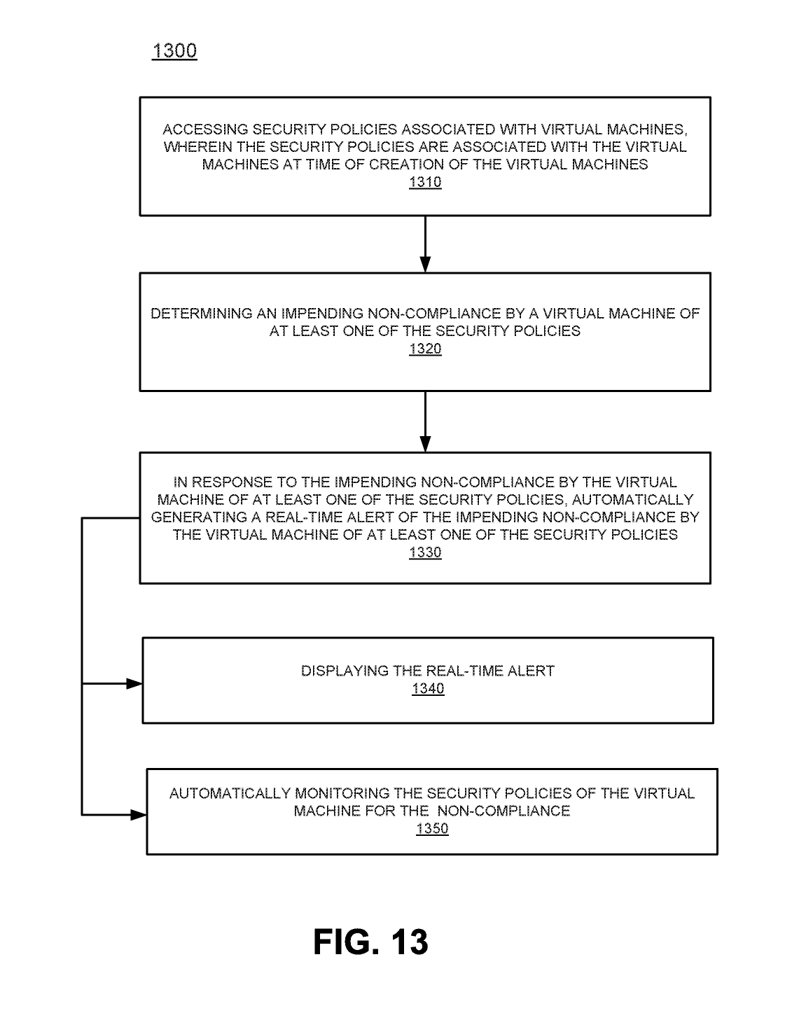

The following discussion sets forth in detail the operation of some example methods of operation of embodiments. With reference to FIGS. 12 and 13, flow diagrams 1200 and 1300 illustrate example procedures used by various embodiments. Flow diagrams 1200 and 1300 include some procedures that, in various embodiments, may include some steps that are carried out by a processor under the control of computer-readable and computer-executable instructions. In this fashion, procedures described herein and in conjunction with flow diagrams 1200 and 1300 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in flow diagrams 1200 and 1300 such procedures are examples. That is, embodiments are well suited to performing various other procedures or variations of the procedures recited in flow diagrams 1200 and 1300. Likewise, in some embodiments, the procedures in flow diagrams 1200 and 1300 may be performed in an order different than presented and/or not all of the procedures described in one or more of these flow diagrams may be performed.

FIG. 12 depicts a process flow diagram 1200 of a method for automatic real-time alerting of security hardening non-compliance, according to various embodiments.

At 1210, accessing security policies of virtual machines in a virtualization infrastructure. For example, compliance manager 230 of centralized management tool 130 accesses security policies of virtual machines 210 and 220 in virtualization infrastructure 200.

At 1220, determining impending non-compliance of at least one of the security policies. For example, centralized compliance manager 230 automatically determines if the virtual machines are in impending non-compliance of security hardening based on the security policies associated with the virtual machines. In such an example, virtual machine 220 is about to be assigned a workload that requires security policy 314, however, virtual machine 220 is assigned security policy 310 which would be non-compliant for the workload.

At 1230, in response to the impending non-compliance of at least one of the security policies, automatically generating a real-time alert of the impending non-compliance of at least one of the security policies. For example, when centralized compliance manager 230 determines that virtual machine 220 is non-compliant to HIPPA security requirements, centralized compliance manager 230 immediately generates an alert that virtual machine 220 is non-compliant to HIPPA security requirements.

At 1240, displaying the real-time alert. For example, the alert generated by centralized compliance manager 230 is displayed on a UI of centralized management tool 130 for viewing by an IT administrator.

At 1250, automatically monitoring the security policies of the virtual machines for the impending non-compliance. For example, centralized compliance manager 230 periodically monitors virtualization infrastructure 200 to determine if any virtual machines in the virtualization infrastructure are in non-compliance or have an impending non-compliance.

It is noted that any of the procedures, stated above, regarding flow diagram 1200 may be implemented in hardware, or a combination of hardware with firmware and/or software. For example, any of the procedures are implemented by a processor(s) of a cloud environment and/or a computing environment.

FIG. 13 depicts a process flow diagram 1300 of a method for automatic real-time alerting of security hardening non-compliance, according to various embodiments.

At 1310, accessing security policies associated with virtual machines, wherein said security policies are associated with said virtual machines at time of creation of said virtual machines. For example, compliance manager 230 of centralized management tool 130 accesses security policies of virtual machines 210 and 220 in virtualization infrastructure 200.

At 1320, determining non-compliance of at least one of said security policies. For example, centralized compliance manager 230 automatically determines if the virtual machines are in non-compliance of security hardening based on the security policies associated with the virtual machines. In such an example, virtual machine 220 executes a workload that requires security policy 314. However, virtual machine 220 is associated with security policy 310 which is non-compliant for the workload.

At 1330, in response to said non-compliance of at least one of said security policies, automatically generating a real-time alert of said impending non-compliance of at least one of said security policies. For example, when centralized compliance manager 230 determines that virtual machine 220 is non-compliant to HIPPA security requirements, centralized compliance manager 230 immediately generates an alert that virtual machine 220 is non-compliant to HIPPA security requirements.

At 1340, displaying the real-time alert. For example, the alert generated by centralized compliance manager 230 is displayed on a UI of centralized management tool 130 for viewing by an IT administrator.

At 1350, automatically monitoring the security policies of the virtual machines for the non-compliance. For example, centralized compliance manager 230 periodically monitors virtualization infrastructure 200 to determine if any virtual machines in the virtualization infrastructure are in non-compliance of security hardening requirements.

It is noted that any of the procedures, stated above, regarding flow diagram 1300 may be implemented in hardware, or a combination of hardware with firmware and/or software. For example, any of the procedures are implemented by a processor(s) of a cloud environment and/or a computing environment.

Iv. Security Hardening of Virtual Machines at Time of Creation

### A. Embodiments of Security Hardening of Virtual Machines at Time of Creation

As will be described in further detail below, centralized management tool 130, in various embodiments, provides for security hardening of virtual Machines at time of creation.

Referring to FIG. 2, centralized management tool 130 enables for the centralized management of virtualization infrastructure, as described above. In one embodiment, centralized management tool 130 (e.g., vRealize Automation) is a unified cloud management software product that is capable of managing multiple hypervisors, physical infrastructure, public cloud services and the like. More specifically, centralized management tool 130 provides administrators with the ability to provision and configure storage, network and compute resources across multiple platforms. It also allows administrators to automate application delivery and simplify the deployment of multi-tiered applications while managing multi-vendor and multi-cloud infrastructures.

Additionally, centralized management tool 130 enables for user configuration of a security policy at time of creation of a virtual machine. For example, during creation of a virtual machine, a user has access to the parameters of a security policy (e.g., parameters of security policies 310, 312 and 314) and is able to select the values of the parameters. Once the parameters and values of the parameters are selected the customized security policy is then associated with the virtual machine.

The workloads executed or running on the virtual machine will have the security hardening that is associated with the virtual machine. For example, if a virtual machine is security hardened based on the association with security policy 314, then the workload executing on the virtual machine will also be security hardened.

In various embodiments, virtualization infrastructure 200 includes centralized compliance manager 230 (e.g., vRealize Operations Manager) for providing automated real-time alerts when there is non-compliance of security hardening. In general, centralized compliance manager 230 checks the compliance of virtualization infrastructure 200 against specific standards and best practices that are applicable for the environment. In response to determining non-compliance, centralized compliance manager 230 generates an alert to indicate non-compliance or impending non-compliance. Specific standards may be governmental standards, HIPPA security standards, contractually based standards, etc.

More specifically, centralized compliance manager 230 accesses the virtual machines in virtualization infrastructure 200 to determine whether the security policies associated with the virtual machines are in non-compliance or are impending non-compliance.

Alternatively, in one embodiment, during creation of a virtual machine, the security may be hidden from the user and default settings of the security policies are automatically associated with the virtual machine. Accordingly, the default settings of the associated security policy of the virtual machine is also the default setting of the workload provisioned on the virtual machine.

### B. Example Methods of Operation

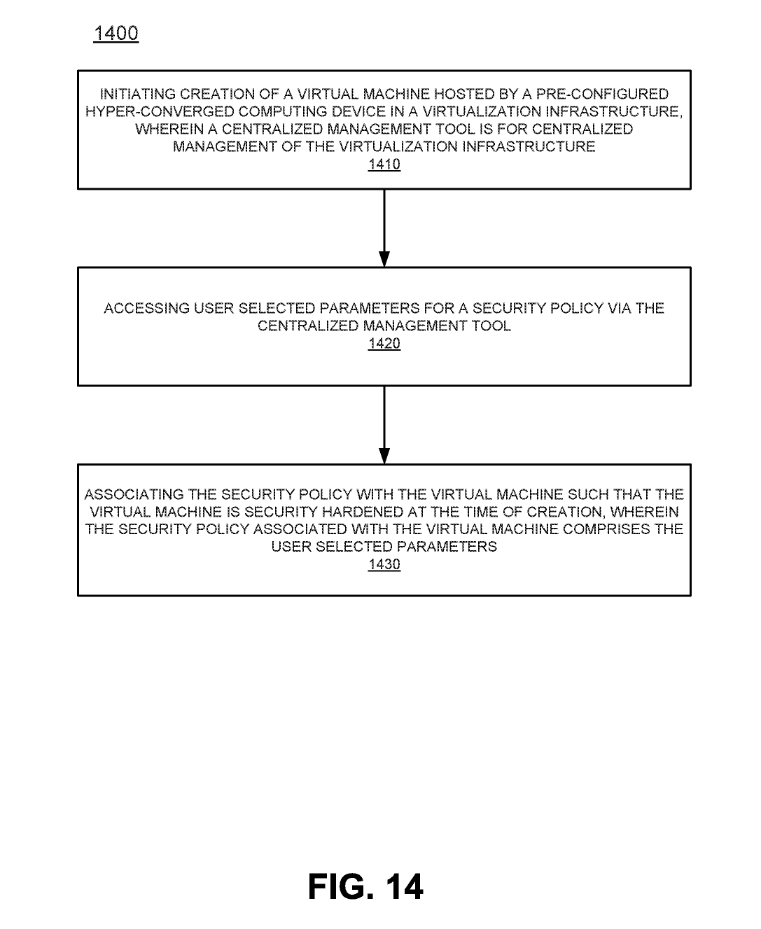

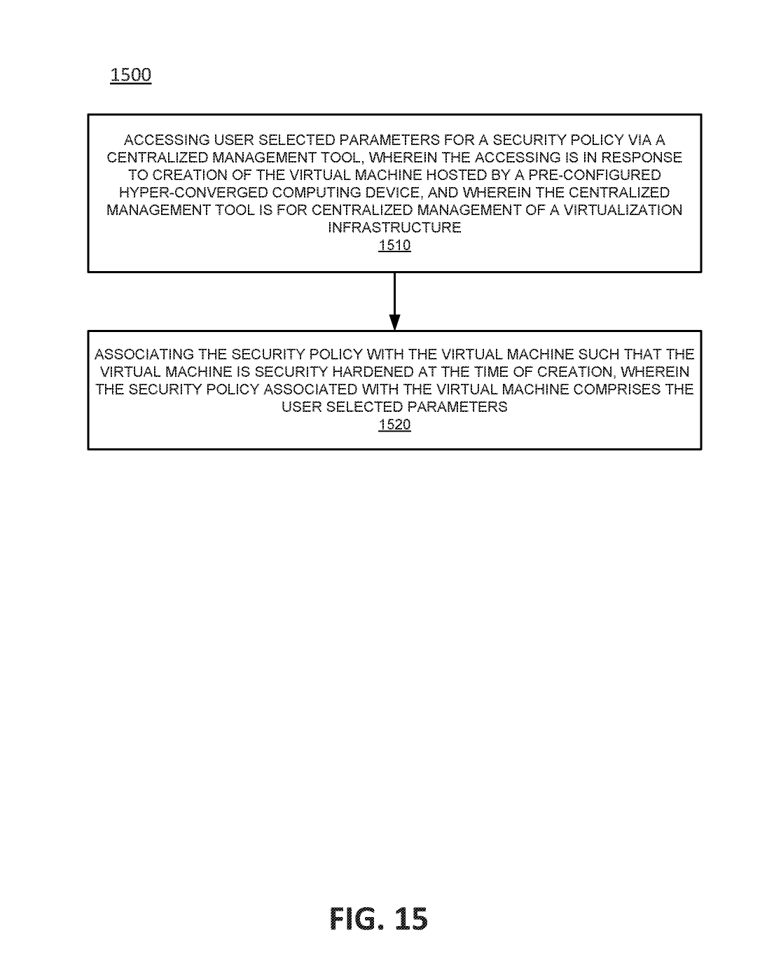

The following discussion sets forth in detail the operation of some example methods of operation of embodiments. With reference to FIGS. 14 and 15, flow diagrams 1400 and 1500 illustrate example procedures used by various embodiments. Flow diagrams 1400 and 1500 include some procedures that, in various embodiments, may include some steps that are carried out by a processor under the control of computer-readable and computer-executable instructions. In this fashion, procedures described herein and in conjunction with flow diagrams 1400 and 1500 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments. The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in flow diagrams 1400 and 1500 such procedures are examples. That is, embodiments are well suited to performing various other procedures or variations of the procedures recited in flow diagrams 1400 and 1500. Likewise, in some embodiments, the procedures in flow diagrams 1400 and 1500 may be performed in an order different than presented and/or not all of the procedures described in one or more of these flow diagrams may be performed.

FIG. 14 depicts a process flow diagram 1400 of a method for security hardening of virtual machines at time of creation, according to various embodiments.

At 1410, initiating creation of a virtual machine hosted by a pre-configured hyper-converged computing device in a virtualization infrastructure, wherein a centralized management tool is for centralized management of the virtualization infrastructure. For example, instructions are provided by a user (e.g., IT administrator) to create virtual machine 220 for use in virtualization infrastructure 200. Virtual machine 220 is hosted by appliance 205 which is a pre-configured hyper-converged computing device.

At 1420, accessing user selected parameters for a security policy via the centralized management tool. For example, a user selects the parameters and parameter values that are a part of the security policy. The selected parameters/values are received by centralized management tool 130 for subsequent association of the security policy with the virtual machine.

At 1430, associating the security policy to the virtual machine such that the virtual machine is security hardened at the time of creation, wherein the security policy associated with the virtual machine comprises the user selected parameters. For example, centralized management tool 130 receives the instructions to create the virtual machine and also receives instructions regarding the customized security policy. In response, during the creation of virtual machine 220, centralized management tool 130 automatically associates security policy 222 (e.g., a customized security policy) with virtual machine 220. As a result, virtual machine 220 is automatically security hardened at the time of creation with the customized security policy.

It is noted that any of the procedures, stated above, regarding flow diagram 1400 may be implemented in hardware, or a combination of hardware with firmware and/or software. For example, any of the procedures are implemented by a processor(s) of a cloud environment and/or a computing environment.

FIG. 15 depicts a process flow diagram 1500 of a method for security hardening of virtual machines at time of creation, according to various embodiments.

At 1510, accessing user selected parameters for a security policy via a centralized management tool, wherein the accessing is in response to creation of the virtual machine hosted by a pre-configured hyper-converged computing device, and wherein the centralized management tool is for centralized management of a virtualization infrastructure. For example, centralized management tool 130 receives the instructions to create the virtual machine and also receives instructions regarding the customized security policy.

At 1520, associating the security policy to the virtual machine such that the virtual machine is security hardened at the time of creation, wherein the security policy associated with the virtual machine comprises the user selected parameters. For example, during the creation of virtual machine 220, centralized management tool 130 automatically associates security policy 222 (e.g., a customized security policy) with virtual machine 220. As a result, virtual machine 220 is automatically security hardened at the time of creation with the customized security policy.

It is noted that any of the procedures, stated above, regarding flow diagram 1500 may be implemented in hardware, or a combination of hardware with firmware and/or software. For example, any of the procedures are implemented by a processor(s) of a cloud environment and/or a computing environment.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

1. A computer-implemented method for automatic real-time alerting of security hardening non-compliance, said computer-implemented method comprising:
accessing security policies of a virtual machine in a virtualization infrastructure;
determining impending non-compliance by said virtual machine of at least one of said security policies; and
in response to said impending non-compliance by said virtual machine of said at least one of said security policies, automatically generating a real-time alert of said impending non-compliance by said virtual machine of said at least one of said security policies.

2. The computer-implemented method of claim 1, further comprising:
causing said real-time alert to be displayed by a computer system.

3. The computer-implemented method of claim 1, further comprising:
automatically monitoring said security policies of said virtual machine for said impending non-compliance.

4. The computer-implemented method of claim 1, wherein said virtual machine is hosted by one or more pre-configured hyper-converged computing devices.

5. The computer-implemented method of claim 1, further comprising:
automatically associating said security policies with said virtual machine at time of creation of said virtual machine.

6. The computer-implemented method of claim 1, wherein said impending non-compliance of said at least one of said security policies comprises an improper security policy for a workload of said virtual machine.

7. A non-transitory computer-readable storage medium having instructions embodied therein that when executed cause a computer system to perform a method of automatic real-time alerting of security hardening non-compliance, the method comprising:
accessing security policies associated with a virtual machine, wherein said security policies are associated with said virtual machine at time of creation of said virtual machine;
determining non-compliance by said virtual machine of at least one of said security policies; and
in response to said non-compliance by said virtual machine of said at least one of said security policies, automatically generating a real-time alert of said impending non-compliance by said virtual machine of said at least one of said security policies.

8. The non-transitory computer-readable storage medium of claim 7, further comprising:
causing said real-time alert to be displayed by said computer system.

9. The non-transitory computer-readable storage medium of claim 7, further comprising:
automatically monitoring said security policies of said virtual machine for said non-compliance.

10. The non-transitory computer-readable storage medium of claim 7, wherein said virtual machine is hosted by at least one pre-configured hyper-converged computing devices.

11. The non-transitory computer-readable storage medium of claim 7, wherein said non-compliance by said virtual machine of said at least one of said security policies comprises an improper security policy for a workload of said virtual machine.
